(19) United States
(12) Patent Application Publication
(10) Pub. No.: US 2025/0105710 A1
(43) Pub. Date: Mar. 27, 2025

(54) METHOD OF PRODUCING ROTATING ELECTRIC MACHINE

(71) Applicant: HONDA MOTOR CO., LTD., Tokyo (JP)

(72) Inventors: Shuhei Tanaka, Wako-shi (JP); Atsushi Kubota, Wako-shi (JP); Naoya Naitoh, Wako-shi (JP)

(21) Appl. No.: 18/885,777

(22) Filed: Sep. 16, 2024

(30) Foreign Application Priority Data
Sep. 21, 2023 (JP) 2023-154143

(51) Int. Cl. H02K 15/02; H02K 1/24

(52) U.S. Cl. CPC H02K 15/022; H02K 1/24

(57) ABSTRACT

This method of producing a rotating electric machine is a method of producing a rotating electric machine in which a plurality of coils are formed by winding a winding around each of a plurality of teeth arranged in a circumferential direction of a motor and plate-shaped slot poles which each insulate between a pair of coils adjacent in the circumferential direction of the motor are disposed between the pair of coils, including: an electrical parts assembly step of obtaining annular electrical parts having the coils formed on each of the plurality of teeth arranged in the circumferential direction of the motor; a pole insertion step of inserting the slot pole having a foam insulation sheet attached only to an end portion on one side in an axial direction of the motor between a pair of coils adjacent in the circumferential direction of the motor in the electrical parts; a first heating step of loading the electrical parts having the slot pole inserted therein in a first heating furnace having a temperature lower than a temperature at which the foam insulation sheet foams and heating the electrical parts; a first varnish dripping step of dripping varnish onto each of the coils from the other side in the axial direction of the motor of the electrical parts after the first heating step; a first varnish curing step of loading the electrical parts after the first varnish dripping step in the first heating furnace again and curing the varnish dripped in the first varnish dripping step; a sheet foaming step of loading the electrical parts after the first varnish curing step in a second heating furnace having a temperature higher than that of the first heating furnace and foaming the foam insulation sheet; a second varnish dripping step of dripping the varnish onto a disposition position of each of the slot poles from the other side in the axial direction of the motor of the electrical parts after the sheet foaming step; and a second varnish curing step of loading the electrical parts after the second varnish dripping step in the second heating furnace again and curing the varnish dripped in the second varnish dripping step.

### CROSS-REFERENCE TO RELATED APPLICATION

The present application claims priority based on Japanese Patent Application No. 2023-154143, filed Sep. 21, 2023, the content of which is incorporated herein by reference.

### BACKGROUND OF THE INVENTION

### Field of the Invention

The present invention relates to a method of producing a rotating electric machine.

### Description of Related Art

In recent years, efforts to realize a low-carbon or decarbonized society have become active and research and development concerning electrification techniques is being conducted to reduce an amount of CO2 emissions and improve energy efficiency in vehicles as well.

For example, in rotating electric machines such as vehicle drive motors, a winding field type is adopted instead of the mainstream embedded magnet type in some cases. Winding field type motors have coils disposed in a rotor instead of a permanent magnet and a magnetic flux occurs in the rotor by passing a current through the coils. In winding field type motors, it is expected that the winding field type motors will have a highly efficient operation by making them so that an amount of magnetic flux of a rotor can be adjusted and there is no concern concerning the stable supply of rare earths because a permanent magnet is not used.

That is to say, at least one of a stator and a rotor of a motor includes a circular annular part, a plurality of cores (teeth) radially protruding inward or outward in a radial direction of the annular part, and a coil obtained by winding a conducting wire around an outer circumference of each of the cores.

For example, Japanese Patent No. 4593291 discloses that, in a method of producing a stator (electrical parts), varnish is able to be applied to the entire coil with a small amount of dripping by pre-heating a stator main body and then dripping the varnish onto the coil and allowing the varnish which has been brought into contact with the coil, has a raised temperature, and has a lowered viscosity to permeate the coil.

### SUMMARY OF THE INVENTION

Incidentally, between coils adjacent in a circumferential direction of a motor, a plate-like member (slot pole) which insulates between the coils and fixes positions of the coils is disposed. Large and small gaps are formed between the slot pole and the coil due to the unevenness of the winding of the outermost layer of the coil. For this reason, there is a concern that, when it is attempted to fill the disposition position of the slot pole with the varnish, some of the varnish will not stay in the gaps and flow down, resulting in insufficient varnish filling.

On the other hand, it is also conceivable that filling with varnish be performed by inserting a foam insulation sheet together with a slot pole between coils, first foaming the foam insulation sheet to fill gaps with it.

Here, the foaming temperature of the foam insulation sheet is higher than the curing temperature of the varnish. In addition, after foaming the foam insulation sheet, the workpiece is temporarily cooled down and then heated again to a temperature appropriate for varnish penetration to fill it with the varnish. For this reason, improvements are required as it increases the energy required for completing filling with the varnish.

An object of an aspect of the present invention is to provide a method of producing a rotating electric machine which can prevent insufficient filling with varnish and reduce an energy required for completing filling with varnish. Also, this in turn contributes to improving energy efficiency.

In order to achieve the above object, a method of producing a rotating electric machine according to an aspect of the present invention employs the following constitution.

(1) An aspect of the present invention is a method of producing a rotating electric machine in which a plurality of coils are formed by winding a winding around each of a plurality of teeth arranged in a circumferential direction of a motor and plate-shaped slot poles which each insulate between a pair of coils adjacent in the circumferential direction of the motor are disposed between the pair of coils, including: an electrical parts assembly step of obtaining annular electrical parts having the coils formed on each of the plurality of teeth arranged in the circumferential direction of the motor; a pole insertion step of inserting the slot pole having a foam insulation sheet attached only to an end portion on one side in an axial direction of the motor between a pair of coils adjacent in the circumferential direction of the motor in the electrical parts; a first heating step of loading the electrical parts having the slot pole inserted therein in a first heating furnace having a temperature lower than a temperature at which the foam insulation sheet foams and heating the electrical parts; a first varnish dripping step of dripping varnish onto each of the coils from the other side in the axial direction of the motor of the electrical parts after the first heating step; a first varnish curing step of loading the electrical parts after the first varnish dripping step in the first heating furnace again and curing the varnish dripped in the first varnish dripping step; a sheet foaming step of loading the electrical parts after the first varnish curing step in a second heating furnace having a temperature higher than that of the first heating furnace and foaming the foam insulation sheet; a second varnish dripping step of dripping the varnish onto a disposition position of each of the slot poles from the other side in the axial direction of the motor of the electrical parts after the sheet foaming step; and a second varnish curing step of loading the electrical parts after the second varnish dripping step in the second heating furnace again and curing the varnish dripped in the second varnish dripping step.

According to an aspect of (1) above, in the electrical parts having the plurality of teeth arranged in the circumferential direction of the motor and the coils, the slot pole having the foam insulation sheet attached only to the end portion on one side in the axial direction of the motor is inserted between the pair of coils adjacent in the circumferential direction of the motor. After pre-heating the electrical parts in the first heating furnace having a relatively lower temperature after the electrical parts assembly step, the varnish is dripped onto each of the coils to permeate the coil. After that, the electrical parts are loaded in the first heating furnace again and the varnish is cured. In this way, by coating only each of the coils with the varnish, an amount of varnish to be used can be reduced, compared to a constitution in which electrical parts are immersed in a dripping bath and coating with varnish is performed. Furthermore, by minimizing the coating of the portions around the coil with the varnish, at the time of disassembling the electrical parts, the coil can be pushed out and pulled out easily. In addition, at the beginning of the step of producing the electrical parts, by continuously using the first heating furnace having a relatively low temperature, it is possible to reduce the energy required from pre-heating the electrical parts to curing the varnish.

After curing the varnish dripped on the coil, the electrical parts are loaded in the second heating furnace having the temperature higher than that of the first heating furnace and the foam insulation sheet is caused to foam. Thus, the gap between the coil and the slot pole is closed around the end portion on one side in the axial direction of the motor of the slot pole. After that, by dripping the varnish onto the disposition place of the slot pole from the other side in the axial direction of the motor, it is possible to fill the portion around the slot pole with the varnish while preventing the dripped varnish from leaking from one side in the axial direction of the motor. The electrical parts are loaded in the second heating furnace again and the varnish filled around the slot pole is cured. At this time, it is possible to perform the curing using residual heat in the second heating furnace.

In this way, in the step of filling the rotating electric machine with the varnish, by performing setting in order of increasing a temperature until the process reaches the sheet foaming step and performing setting in order of decreasing a temperature after the sheet foaming step, it is possible to reduce the energy required for completing the filling with the varnish while preventing insufficient filling with the varnish.

According to an aspect of the present invention, it is possible to provide a method of producing a rotating electric machine which can prevent insufficient filling of varnish and reduce energy required for completing filling with the varnish.

### BRIEF DESCRIPTION OF THE DRAWINGS

FIG. 1 is an exploded perspective view of a motor in an embodiment of the present invention.

FIG. 2 is a plan view of a part of a rotor of the motor in a circumferential direction when viewed from an axial direction, including a partial cross section.

FIG. 3 is a perspective view including a cross section in the axial direction of the rotor.

FIG. 4 is a flowchart for describing a process of producing the rotor.

FIG. 5 is an explanatory diagram showing a temperature history of a heating furnace in the process of producing the rotor, FIG. 5(a) shows a temperature history in the embodiment, and FIG. 5(b) shows a temperature history in a comparative example.

### DESCRIPTION OF EMBODIMENTS

An embodiment of the present invention will be explained below with reference to the drawings.

### <Motor 1>

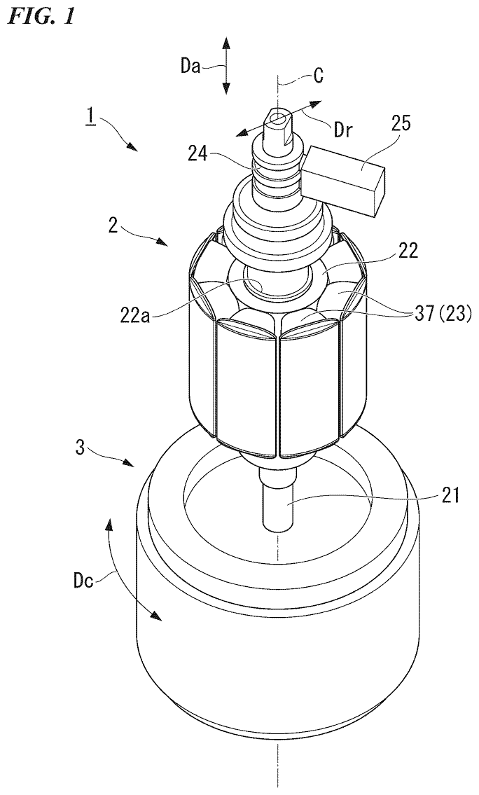

FIG. 1 is an exploded perspective view of a motor (rotating electric machine) 1 to which an embodiment of the present invention is applied.

As shown in FIG. 1, the motor 1 includes a rotor 2, a stator 3, and a casing (not shown) which covers the rotor 2 and the stator 3. In the embodiment, the rotor 2 is disposed on an inner circumference side with respect to the stator 3. That is to say, the motor 1 is an inner rotor type motor.

The motor 1 in the embodiment is an electric vehicle drive motor. Furthermore, the motor 1 in the embodiment is a winding field type motor and has a rotor structure in which a magnetic field winding (coils 37) is used instead of a permanent magnet. The motor 1 generates a magnetic flux in the rotor 2 by applying a direct current (DC) from the outside to a magnetic field winding and allows a field magnetic flux to be adjusted.

### <Rotor 2>

The rotor 2 has a rotating shaft 21, a rotor core 22, a plurality of magnetic pole parts 23, and a commutator 24.

The rotating shaft 21 extends in an axial direction (an axial direction of the motor) Da. The rotating shaft 21 is supported by a casing via a bearing (both not shown). The rotating shaft 21 is rotatably supported in a circumferential direction (a circumferential direction of the motor) Dc around an axis C extending in the axial direction Da.

The rotor core 22 is provided on an outer side (an outer circumference side) in a radial direction (a radial direction of the motor) Dr centering on the axis C with respect to the rotating shaft 21. The rotor core 22 is formed to have a cylindrical shape in which the axis C thereof is provided as an axial center. When viewed from the axial direction Da, a shaft insertion hole 22a through which the rotating shaft 21 is inserted is formed in a central portion of the rotor core 22. The rotor core 22 is rotatable in the circumferential direction Dc together with the rotating shaft 21.

The plurality of magnetic pole parts 23 are disposed at equal intervals in the circumferential direction Dc on the outer circumferential portion of the rotor core 22. Each of the magnetic pole parts 23 includes the coil 37. The coils 37 are formed by winding windings 32 around an outer circumference of teeth 35 formed on the rotor core 22 via an insulator 38. The coil 37 and the insulator 38 will be described in detail later.

The commutator 24 is coaxially provided on one end portion of the rotating shaft 21. The commutator 24 is rotatable together with the rotating shaft 21 in the circumferential direction Dc. A brush 25 supported by the casing is in opposing contact with the commutator 24 in the radial direction Dr.

### <Stator 3>

The stator 3 is disposed on the outer circumference side in the radial direction Dr with respect to the rotor core 22 with a gap (air gap) therebetween. The stator 3 is fixed to the inner circumference side in the radial direction Dr of the casing. The stator 3 has a stator core and a plurality of magnetic pole parts (neither of which are shown).

### <Details of Rotor 2>

The rotor 2 will be described in more detail below.

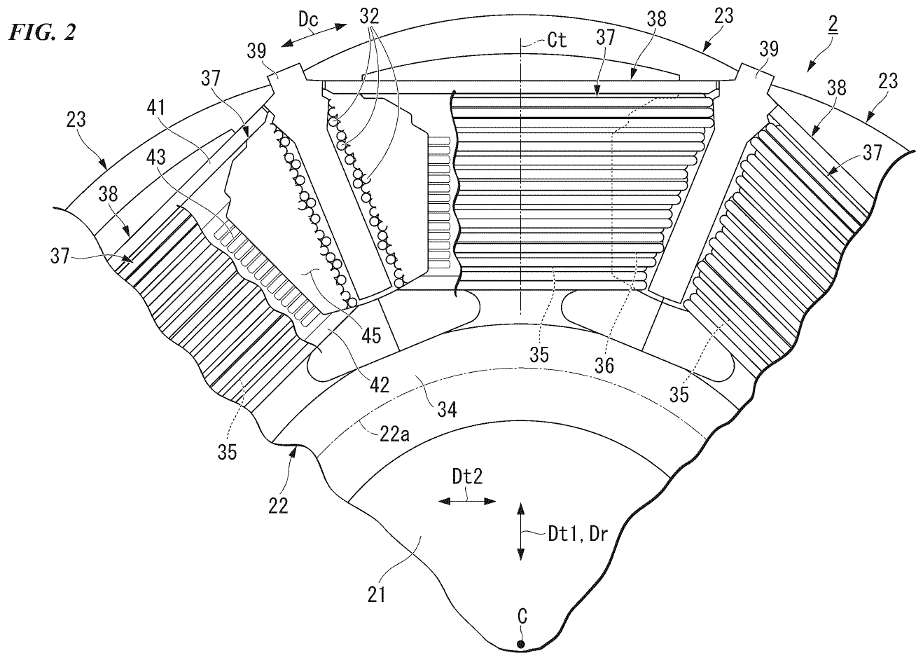

As shown in FIG. 2, the rotor core 22 integrally has an annular part 34 and the plurality of teeth 35.

The annular part 34 is formed on the inner circumference side (the rotating shaft 21 side) of the rotor core 22. The annular part 34 extends in the circumferential direction Dc and is formed to have an annular shape when viewed from the axial direction Da.

The plurality of teeth 35 are formed at equal intervals in the circumferential direction Dc. Each of the teeth 35 extends toward the outer circumferential side in the radial direction Dr from the outer circumferential portion of the annular part 34. A slot 36 is formed between the teeth 35 adjacent in the circumferential direction Dc. The slot 36 has a form in which the outer circumference side of the rotor core 22 is cut out.

The slot 36 and the teeth 35 are formed to have the same number (eight in the embodiment). The rotor core 22 may have a constitution in which it is divisible for each plurality of teeth 35 in the circumferential direction Dc. Aline Ct in the drawing indicates a central axis along the central axis (in the protrusion direction of the teeth 35 (in the radial direction Dr of the motor)) of the teeth 35. Hereinafter, the protrusion direction of the teeth 35 will be referred to as an axial direction Dt1 of the teeth and a direction perpendicular to the axial direction Dt1 of the teeth will be referred to a radial direction Dt2 of the teeth.

The windings 32 are conducting wires (for example, a copper wire) and are held in the rotor core 22 in the form of the coils 37. The winding 32 is wound around each of the plurality of teeth 35 via the insulator 38 made of an insulating resin. When viewed from in the axial direction Dt1 of the teeth, the winding 32 is wound such that a plurality of layers thereof are laminated on the outer circumference of the teeth 35. By winding the winding 32 around each of the teeth 35, the plurality of coils 37 arranged at intervals in the circumferential direction Dc are formed in the rotor 2. Slot poles (insulating plate) 39 made of an insulating resin such as PPS are inserted between a pair of coils 37 adjacent in the circumferential direction Dc.

### <Insulator 38>

As shown in FIG. 2, the insulator 38 has a flange-shaped outer circumferential piece 41 provided on one end side (the outer circumference side of the motor) in the axial direction Dt1 of the teeth, a flange-shaped inner circumferential piece 42 provided on the other end side (the inner circumference side of the motor) in the axial direction Dt1 of the teeth, and a cylindrical side wall part (winding part) 43 in which the outer circumferential piece 41 and the inner circumferential piece 42 are connected to each other. An internal space having three sides surrounded by the opposing surfaces of the outer circumferential piece 41 and the inner circumferential piece 42 and the outer surfaces of the winding part 43 corresponds to storage parts 45 which store the coils 37 in which the windings 32 are laminated. The slot 36 is formed using a pair of storage parts 45 adjacent in the circumferential direction Dc of the motor. The windings 32 are densely disposed in a so-called bale arrangement inside the storage part 45.

<Filling with Varnish W>

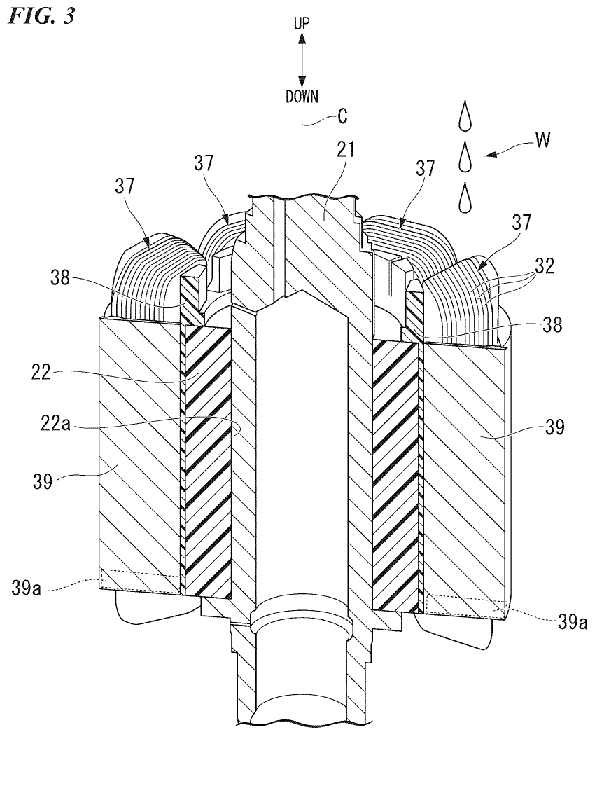

As shown in FIGS. 2 and 3, each of the slot poles 39 has a rectangular flat plate shape in the radial direction Dr of the motor and in the axial direction Da of the motor. The slot pole 39 insulates between the pair of coils 37 adjacent in the circumferential direction Dc of the motor and fixes the position of each of the coils 37. Particularly, unlike the stator 3 fixed to the casing, the rotor 2 of a winding field type rotates. Thus, the fixing of the coils 37 is required to prevent the windings from scattering due to a centrifugal force. An uneven gap due to the unevenness of the outermost layer of the coil 37 is formed between both side surfaces of the slot pole 39 in the circumferential direction Dc of the motor and the coil 37 adjacent to the slot pole 39. The filling with the varnish W (FIG. 3 shows that it drips toward the rotor 2) is performed so that this gap is filled.

For example, if the winding of the coil 37 is wound in the axial direction Dt1 of the teeth, a method of inserting a wedge-shaped member into a space between the coils 37 and filling a minute gap between this member and the coil 37 with the varnish W, the molding resin, or the like is considered.

On the other hand, as shown in the embodiment, if a tapered winding in which the number of turns of the coils 37 is increased toward the outside in the radial direction Dr of the motor is adopted, the unevenness of the outermost layer of the coils 37 becomes uneven and the gap between the slot pole 39 and the coil 37 becomes larger. For this reason, even when the disposition position of the slot pole 39 is simply attempted to be filled with the varnish W, there is a concern that some of it leaks out of the rotor 2, resulting in insufficient filling with the varnish W. Furthermore, the filling using a mold requires additional step and a sealing structure, resulting in increased costs.

In the embodiment, in order to reliably perform the filling with the varnish W even when the gap between the slot pole 39 and the coil 37 becomes larger, foam insulation sheets (for example, a foam insulation paper, for example, foam insulation paper having a polyethylene naphthalate (PEN) film as a base material and foam adhesive layers on both sides) 39a are utilized.

As shown in FIG. 3, the foam insulation sheet 39a is disposed only at an end portion on one side of the slot pole 39 in the axial direction Da of the motor. The foam insulation sheets 39a are disposed on both sides of the slot pole 39 in the circumferential direction Dc of the motor. While attached to the slot pole 39 in advance using an epoxy resin or the like, in an electrical parts assembly step S1 which will be described later, the foam insulation sheet 39a is inserted between the pair of coils 37 adjacent in the circumferential direction Dc of the motor from the outside to the inside in the radial direction Dr of the motor.

After that, in a sheet foaming step S6 which will be described later, the foam insulation sheets 39a are foamed on both surface sides at an end portion on one side of the slot pole 39 in the axial direction Da of the motor. Thus, at the end on one side of the slot pole 39 in the axial direction Da of the motor, a large or small gap between the slot pole 39 and the coil 37 can be filled. At an end portion on the other side of the slot pole 39 in the axial direction Da of the motor, the gap between the slot pole 39 and the coil 37 is open. Thus, it is possible to fill the disposition position of the slot pole 39 with the varnish W from the other side in the axial direction Da of the motor. At this time, on one side of the disposition position of the slot pole 39 in the axial direction Da of the motor, the varnish W is dammed using the foam insulation sheet 39a and the filled varnish W is prevented from leaking from one side in the axial direction Da of the motor.

### <Method of Producing Rotor 2>

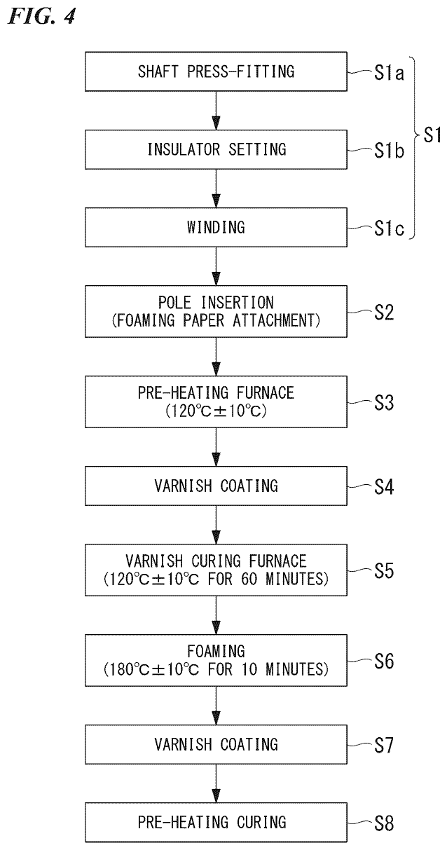

As shown in FIG. 4, a method of producing the rotor 2 in an embodiment has an electrical parts assembly step S1, a pole insertion step S2, a first heating step S3, a first varnish dripping step S4, a first varnish curing step S5, a sheet foaming step S6, a second varnish dripping step S7, and a second varnish curing step S8.

In the electrical parts assembly step S1, the annular rotor 2 in which the coil 37 is formed in each of the plurality of teeth 35 arranged in the circumferential direction Dc of the motor is obtained. The electrical parts assembly step S1 includes a shaft press-fitting step S1a of press-fitting the rotating shaft 21 into a rotor core, an insulator setting step S1b of attaching the insulator 38 to each tooth 35 of the rotor core, and a winding step S1c of winding a winding around the winding part 43 of the insulator 38 to form the coil 37.

In the pole insertion step S2, the slot pole 39 is inserted between the pair of coils 37 adjacent in the circumferential direction Dc of the motor in the rotor 2. In the slot pole 39, on both surfaces of the end portion on one side in the axial direction Da of the motor in a state in which it is assembled to the rotor 2, the foam insulation sheets 39a cut to have a strip shape in which it has a specified width are attached in advance using an epoxy-based adhesive or the like.

In the first heating step S3, the rotor 2 after the pole insertion step S2 and having the slot pole 39 inserted therein is loaded in a first heating furnace at a temperature (for example, 120° C.±10° C.) lower than a temperature (for example, 180° C.±10° C.) at which the foam insulation sheet 39a foams and heated. The set temperature of the first heating furnace is set to a temperature at which the viscosity of the varnish W is reduced and the varnish W easily permeates the coil 37.

In the first varnish dripping step S4, the varnish W is dripped from the other side of the rotor 2 after the first heating step S3 in the axial direction Da of the motor to each of the coils 37. An amount of the varnish W to be dripped may be set in advance to an amount in which it can completely permeate each of the coils 37. By causing the varnish W to permeate each of the coils 37, spaces between the windings 32 and a transition part are fixed. Since the varnish W dripped onto each of the coils 37 permeates each of the coils 37 and is retained, leakage to the outside of the rotor 2 is suppressed.

In the first varnish curing step S5, the rotor 2 after the first varnish dripping step S4 is loaded again into the first heating furnace and the varnish W which has been dripped in the first varnish dripping step is cured. The curing of the varnish W requires heating at, for example, 120° C.±10° C. for 60 to 70 minutes. It is possible to perform the steps from the first heating step S3 to the first varnish curing step S5 by keeping the first heating furnace at a constant temperature of 120° C.±10° C. and the energy consumption of using a heating furnace is reduced.

In the sheet foaming step S6, the rotor 2 after the first varnish curing step S5 is loaded into a second heating furnace at a temperature (for example, 180° C.±10° C.) higher than that of the first heating furnace and the foam insulation sheet 39a is caused to foam. Although the second heating furnace has a constitution in which a set temperature is changed using the same facility as the first heating furnace, the second heating furnace may also have a constitution in which a facility other than the first heating furnace is used. The foaming of the foam insulation sheet 39a requires, for example, heating at 180° C.±10° C. for 10 to 20 minutes. The gap between the slot pole 39 and the coil 37 is filled by foaming the foam insulation sheet 39a on both surface sides at the end portion on one side of the slot pole 39 in the axial direction Da of the motor. In a region other than the end portion on one side of the slot pole 39 in the axial direction Da of the motor, the foam insulation sheet 39a is not provided. In addition, it is possible to fill this region with the varnish W from the other side in the axial direction Da of the motor.

In the second varnish dripping step S7, the varnish W is dripped onto the disposition position of each of the slot poles 39 from the other side of the rotor 2 after the sheet foaming step S6 in the axial direction Da of the motor. An amount of the varnish W to be dripped may be set in advance to an amount in which the gap around each of the slot poles 39 can be filled with the varnish W. The varnish W which has been dripped onto the disposition position of each of the slot poles 39 is prevented from leaking from one side of the rotor 2 in the axial direction Da of the motor by providing the foam insulation sheet 39a at the end portion on one side of the slot pole 39 in the axial direction Da of the motor.

In the second varnish curing step S8, the rotor 2 after the second varnish dripping step S7 is loaded again into the second heating furnace and the varnish W which has been dripped in the second varnish dripping step S7 is cured. After the second varnish dripping step S7, the second heating furnace is used by lowering the set temperature until it reaches 120° C.±10° C. which is the same as that of the first heating furnace. In the second varnish curing step S8, the first heating furnace may be used instead of the second heating furnace.

### <Temperature History of Process of Producing Rotor 2>

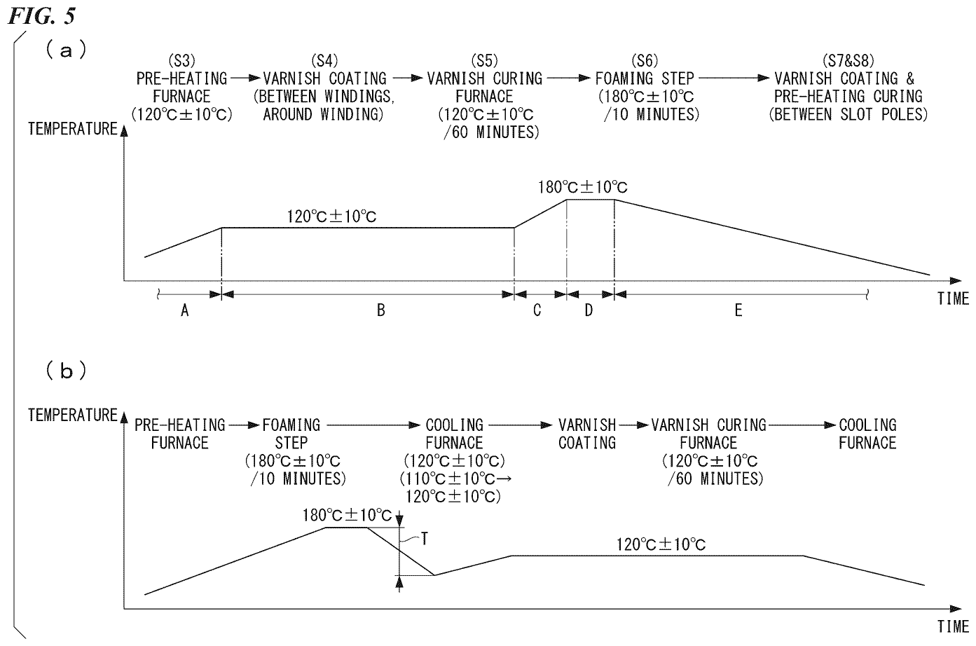

FIG. 5(a) shows a temperature history of the entire process of filling the rotor 2 with the varnish W in the process of producing the rotor 2 in the embodiment. In this example, it is assumed that the first heating furnace and the second heating furnace are constituted using the same heating furnace but have different set temperatures.

In the drawing, Range A indicates a range in which a temperature of the first heating furnace is increased, Range B indicates a range in which a temperature of the first heating furnace is maintained at a specified temperature (120° C.±10° C.), Range C indicates a range in which a temperature of a second heating furnace is increased, Range D indicates a range in which a temperature of the second heating furnace is maintained at a specified temperature (180° C.±10° C.), and Range E indicates a range in which the second heating furnace is cooled (subjected to natural heat radiation).

The temperature of the entire process in the embodiment changes in order of increasing temperature until the process reaches the sheet foaming step S6 (Range D) and changes in order of decreasing a temperature after the sheet foaming step S6.

FIG. 5(b) shows a temperature history of a process of producing a rotor in a comparative example. This comparative example shows a step of performing the sheet foaming step without the dripping or the like of the varnish W after the pole insertion step, first foaming the foam insulation sheet 39a, filling a gap around the slot pole 39, and then performing filling with the varnish W (a step of permeating the coil 37).

In the step in the comparative example, the foaming temperature of the foam insulation sheet 39a is higher than the curing temperature of the varnish W. Thus, after foaming the foam insulation sheet 39a, the rotor 2 is temporarily cooled. After that, after heating the rotor 2 again until it reaches a temperature appropriate for permeation of the varnish W, the appropriate locations are filled with the varnish W. For this reason, the energy required for completing the filling with the varnish W is increased by a temperature difference T when heating the rotor 2 again until it reaches the temperature appropriate for permeation of the varnish W after the cooling of the rotor 2.

On the other hand, in the embodiment, before the sheet foaming step S6 which has the highest setting temperature, while performing the step of causing the varnish W to permeate each of the coils 37, the temperatures of the rotor 2 and the facility are increased in stages. In addition, after the sheet foaming step S6, while performing the step of filling the disposition position of the slot pole 39 with the varnish W, the temperatures of the rotor 2 and the facility are decreased in stages. Thus, there is no loss to increase the temperature once it has been decreased as in the comparative example. In addition, it is possible to reduce the energy required for completing the filling with the varnish W.

As explained above, the method of producing a rotating electric machine in the above embodiment is the method of producing the motor 1 (the rotor 2) in which a winding is wound around each of the plurality of teeth 35 arranged in the circumferential direction Dc of the motor to form the plurality of coils 37 and the plate-shaped slot pole 39 which insulates between the pair of coils 37 adjacent in the circumferential direction Dc of the motor is disposed between the pair of coils 37 includes the electrical parts assembly step S1 of obtaining the annular rotor 2 having the coil 37 formed in each of the plurality of teeth 35 arranged in the circumferential direction Dc of the motor, the pole insertion step S2 of inserting the slot pole 39 having the foam insulation sheet 39a attached only to the end portion on one side in the axial direction Da of the motor between the pair of coils 37 adjacent in the circumferential direction Dc of the motor in the rotor 2, the first heating step S3 of loading the rotor 2 having the slot pole 39 inserted therein in the first heating furnace having the temperature lower than the temperature at which the foam insulation sheet 39a foams and heating the rotor 2, the first varnish dripping step S4 of dripping the varnish W onto each of the coils 37 from the other side in the axial direction Da of the motor of the rotor 2 after the first heating step S3, the first varnish curing step S5 of loading the rotor 2 after the first varnish dripping step S4 in the first heating furnace again and curing the varnish W dripped in the first varnish dripping step S4, the sheet foaming step S6 of loading the rotor 2 after the first varnish curing step S5 in the second heating furnace having the temperature higher than that of the first heating furnace and foaming the foam insulation sheet 39a, the second varnish dripping step S7 of dripping the varnish W onto the disposition position of each of the slot poles 39 from the other side in the axial direction Da of the motor of the rotor 2 after the sheet foaming step S6, and the second varnish curing step S8 of loading the rotor 2 after the second varnish dripping step S7 in the second heating furnace again and curing the varnish W dripped in the second varnish dripping step S7.

According to this constitution, in the rotor 2 having the plurality of teeth 35 arranged in the circumferential direction Dc of the motor and the coils 37, the slot pole 39 having the foam insulation sheet 39a attached only to the end portion on one side in the axial direction Da of the motor is inserted between the pair of coils 37 adjacent in the circumferential direction Dc of the motor. After pre-heating the rotor 2 in the first heating furnace having a relatively low temperature after the electrical parts assembly step S1, the varnish W is dripped onto each of the coils 37 to permeate the coil, and then the rotor 2 is loaded in the first heating furnace again to cure the varnish W. In this way, by coating only each of the coils 37 with the varnish W, the amount of varnish W to be used can be minimized, compared to a constitution in which the rotor 2 is immersed in a dipping bath and the coating with the varnish W is performed. Furthermore, by minimizing the coating of the portions around the coil 37 with the varnish W, at the time of disassembling the rotor 2, the coil 37 can be pushed out and pulled out easily. In addition, at the beginning of the step of producing the rotor 2, by continuously using the first heating furnace having a relatively low temperature, it is possible to reduce the energy required from pre-heating the rotor 2 to curing the varnish W.

After curing the varnish W dripped onto the coil 37, the rotor 2 is loaded in the second heating furnace having the temperature higher than that of the first heating furnace and the foam insulation sheet 39a is caused to foam. Thus, the gap between the coil 37 and the slot pole 39 is closed around the end portion on one side in the axial direction Da of the motor of the slot pole 39. After that, by dripping the varnish W onto the disposition place of the slot pole 39 from the other side in the axial direction Da of the motor, it is possible to fill the portion around the slot pole 39 with the varnish W while preventing the dripped varnish W from leaking from one side in the axial direction Da of the motor. The rotor 2 is loaded in the second heating furnace again and the varnish W filled around the slot pole 39 is cured. At this time, it is possible to perform the curing using residual heat in the second heating furnace.

In this way, in the step of filling the rotating electric machine with the varnish W, by performing setting in order of increasing a temperature until the process reaches the sheet foaming step S6 and performing setting in order of decreasing a temperature after the sheet foaming step S6, it is possible to reduce the energy required for completing the filling with the varnish W while preventing insufficient filling with the varnish W.

The present invention is not limited to the above-described embodiment, and for example, the method of producing a rotating electric machine in the embodiment may be applied to rotating electric machines other than vehicle drive motors. For example, although the rotating electric machine illustrated in the embodiment is an inner rotor type motor, the constitution thereof is not limited to this. For example, the rotating electric machine may be an outer rotor type in which a rotor is disposed on an outer circumference side with respect to a stator. Furthermore, the rotating electric machine is not limited to a motor, but may also be a generator. In order to heat and foam the foam insulation paper, conduction electricity heating of the winding 32 of the rotor 2 may be used. In this case, a large facility such as a heating furnace is not required.

Also, the constitution in the above embodiment is an example of the present invention. In addition, various changes such as replacing the constituent elements of the embodiment with well-known constituent elements can be provided without departing from the gist of the present invention.

### BRIEF DESCRIPTION OF THE REFERENCE SYMBOLS

1: Motor (rotating electric machine)
2: Rotor (electrical parts)
21: Rotating shaft
22: Rotor core
32: Winding
35: Teeth
36: Slot
37: Coil
38: Insulator
39: Slot pole
39a: Foam insulation sheet
Da: Axial direction (axial direction of motor)
Dc: Circumferential direction (circumferential direction of motor)
Dr: Radial direction (radial direction of motor)
Dt1: Axial direction of teeth
Dt2: Radial direction of teeth
S1: Electrical parts assembly step
S2: Pole insertion step
S3: First heating step
S4: First varnish dripping step
S5: First varnish curing step
S6: Sheet foaming step
S7: Second varnish dripping step
S8: Second varnish curing step
W: Varnish

What is claimed is:

1. A method of producing a rotating electric machine in which a plurality of coils are formed by winding a winding around each of a plurality of teeth arranged in a circumferential direction of a motor and plate-shaped slot poles which each insulate between a pair of coils adjacent in the circumferential direction of the motor are disposed between the pair of coils, comprising:
an electrical parts assembly step of obtaining annular electrical parts having the coils formed on each of the plurality of teeth arranged in the circumferential direction of the motor;
a pole insertion step of inserting the slot pole having a foam insulation sheet attached only to an end portion on one side in an axial direction of the motor between a pair of coils adjacent in the circumferential direction of the motor in the electrical parts;
a first heating step of loading the electrical parts having the slot pole inserted therein in a first heating furnace having a temperature lower than a temperature at which the foam insulation sheet foams and heating the electrical parts;
a first varnish dripping step of dripping varnish onto each of the coils from the other side in the axial direction of the motor of the electrical parts after the first heating step;
a first varnish curing step of loading the electrical parts after the first varnish dripping step in the first heating furnace again and curing the varnish dripped in the first varnish dripping step;
a sheet foaming step of loading the electrical parts after the first varnish curing step in a second heating furnace having a temperature higher than that of the first heating furnace and foaming the foam insulation sheet;
a second varnish dripping step of dripping the varnish onto a disposition position of each of the slot poles from the other side in the axial direction of the motor of the electrical parts after the sheet foaming step; and
a second varnish curing step of loading the electrical parts after the second varnish dripping step in the second heating furnace again and curing the varnish dripped in the second varnish dripping step.
